(19) United States
(12) Patent Application Publication
(10) Pub. No.: US 2023/0189017 A1
(43) Pub. Date: Jun. 15, 2023

(54) DATA TRANSMISSION PROCESSING METHOD AND APPARATUS, COMMUNICATION DEVICE AND STORAGE MEDIUM

(71) Applicant: BEIJING XIAOMI MOBILE SOFTWARE CO., LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 17/923,564

(22) PCT Filed: May 8, 2020
(86) PCT No.: PCT/CN2020/089251

§ 371 Date: Nov. 4, 2022

(51) Int. Cl. H04W 16/28; H04W 72/1268; H04W 74/08

(52) U.S. Cl. CPC H04W 16/28; H04W 72/1268; H04W 74/0816

(57) ABSTRACT

A data processing method includes: before an uplink transmission is received on a configured grant-physical uplink shared channel (CG-PUSCH), sending beam recommendation information to a user equipment (UE), where the beam recommendation information at least indicates one or more recommended beams; and the recommended beams can be selected by the UE to perform uplink transmission on the CG-PUSCH.

### CROSS REFERENCE

The present application is a U.S. National Stage of International Application No. PCT/CN2020/089251, filed on May 08, 2020, the contents of all of which are incorporated herein by reference in their entireties for all purposes.

### BACKGROUND

In the related art, if a base station is provided with a plurality of beams to receive uplink transmission on a configured grant-physical uplink shared channel (CG-PUSCH), with different transmission directions, different beams undergo interference differently at the same time, that is, the quality of beam communication is also different. On an unlicensed spectrum, if the base station configures a plurality of beams for user equipment (UE), how to select a CG-PUSCH to perform uplink transmission, so as to ensure the communication quality is required to be further solved in the related art.

### SUMMARY

The disclosure relates to, but is not limited to, the technical field of radio communication, and in particular to a data transmission processing method and apparatus, a communication device, and a storage medium.

According to a first aspect of examples of the disclosure, provided is a data transmission processing method. The method is applied to a base station and includes:

sending beam recommendation information to user equipment (UE) before receiving uplink transmission on a configured grant-physical uplink shared channel (CG-PUSCH);

where the beam recommendation information at least indicates: one or more recommended beams; and the recommended beams may be selected by the UE to perform uplink transmission on the CG-PUSCH.

According to a second aspect of examples of the disclosure, provided is a data transmission processing method. The method is applied to user equipment (UE) and includes:
receiving beam recommendation information sent by a base station; where the beam recommendation information is sent by the base station before receiving uplink transmission on a configured grant-physical uplink shared channel (CG-PUSCH); and
selecting a beam for the UE to perform uplink transmission on the CG-PUSCH according to one or more recommended beams indicated by the beam recommendation information.

According to a third aspect of examples of the disclosure, provided is a communication device. The communication device includes:
a processor; and
a memory used for storing an executable instruction of the processor;
where the processor is configured for implementing the data transmission processing method in any example of the disclosure when running the executable instruction.

### BRIEF DESCRIPTION OF THE DRAWINGS

FIG. 1 is a schematic structural diagram of a radio communication system according to an example.

FIG. 2 is a schematic diagram of a hidden node according to an example.

FIG. 3 is a schematic diagram of an expansion of N configured grant-physical uplink shared channels (CG-PUSCHs) according to an example.

FIG. 4 is a flowchart of a data transmission processing method according to an example.

FIG. 5 is a flowchart of a data transmission processing method according to an example.

FIG. 6 is a flowchart of a data transmission processing method according to an example.

FIG. 7 is a flowchart of a data transmission processing method according to an example.

FIG. 8 is a flowchart of a data transmission processing method according to an example.

FIG. 9 is a block diagram of a data transmission processing apparatus according to an example.

FIG. 10 is a block diagram of a data transmission processing apparatus according to an example.

FIG. 11 is a block diagram of user equipment according to an example.

FIG. 12 is a block diagram of a base station according to an example.

### DETAILED DESCRIPTION

The examples will be described in detail here and shown in the accompanying drawings illustratively. When the following descriptions relate to the accompanying drawings, unless otherwise specified, the same numeral in different accompanying drawings denotes the same or similar element. The implementations described in the following examples do not denote all implementations consistent with the examples of the disclosure. On the contrary, the implementations are merely examples of an apparatus and a method consistent with some aspects of the examples of the disclosure as detailed in the appended claims.

The term used in the examples of the disclosure is for the purpose of describing specific examples merely and is not intended to be restrictive of the examples of the disclosure. The singular forms such as “a” and “this” used in the examples of the disclosure and the appended claims are also intended to include the plural forms, unless otherwise clearly stated in the context. It is also to be understood that the term “and/or” used here refers to and encompasses any of one or more of associated items listed or all possible combinations.

It is to be understood that although the terms first, second, third, etc. may be employed in the examples of the disclosure, to describe various information, these information should not be limited to this. These terms are merely used for distinguishing the same type of information from one another. For example, first information may also be referred to as second information, and similarly, second information may also be referred to as first information, without departing from the scope of the examples of the disclosure. Depending on the context, the word “if” as used here may be interpreted as “at the time of” or “when”, or “in response to determining”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

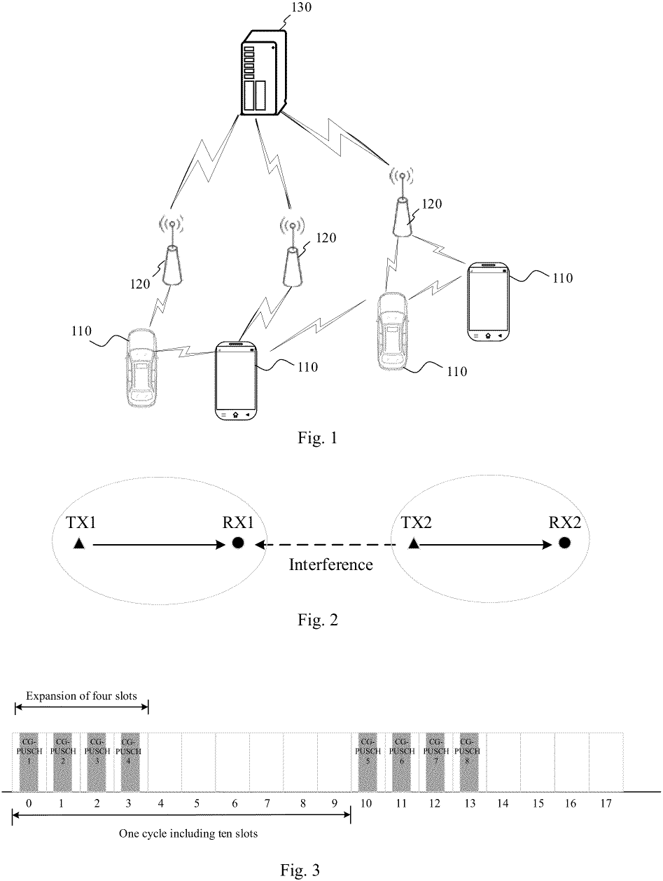

FIG. 1 shows a schematic structural diagram of a radio communication system provided in an example of the disclosure. As shown in FIG. 1, the radio communication system is based on a cellular mobile communication technology, and may include: several pieces of user equipment 110 and several base stations 120.

The user equipment 110 may be a device providing voice and/or data connectivity for a user. The user equipment 110 may communicate with one or more core networks via a radio access network (RAN). The user equipment 110 may be Internet of Things user equipment, such as sensor devices, mobile phones (or “cellular” phones), and computers with Internet of Things user equipment, for example, stationary, portable, pocket, handheld, intra-computer, or vehicle-mounted apparatuses. For example, the user equipment 110 may be a station (STA), a subscriber unit, a subscriber station, a mobile station, a mobile, a remote station, an access point, a remote terminal, an access terminal, a user terminal, a user agent, a user device, or user equipment. Alternatively, the user equipment 110 may be a device of an unmanned aerial vehicle. Alternatively, the user equipment 110 may be an in-vehicle device, for example, a trip computer with a radio communication function, or radio user equipment to which a trip computer is externally connected. Alternatively, the user equipment 110 may be a roadside device, for example, a street lamp, a signal lamp, another roadside device, etc. with the radio communication function.

Each of the base stations 120 may be a network-side device in the radio communication system. The radio communication system may be a 4th generation mobile communication (4G) system, which is also referred to as a long term evolution (LTE) system. Alternatively, the radio communication system may also be a 5th generation mobile communication (5G) system, which is also referred to as a new radio (NR) system or a 5G NR system. Alternatively, the radio communication system may be a next generation system following the 5G system. An access network of the 5G system may be referred to as a new generation-radio access network (NG-RAN).

Each of the base stations 120 may be an evolved node B (eNB) employed in the 4G system. Alternatively, each of the base stations 120 may be a next generation node B (gNB) employing a centralized-distributed architecture in the 5G system. When employing the centralized-distributed architecture, each of the base stations 120 generally includes a central unit (CU) and at least two distributed units (DUs). The central unit is provided with a protocol stack of a packet data convergence protocol (PDCP) layer, a radio link control (RLC) layer, and a media access control (MAC) layer. Each of the distributed units is provided with a protocol stack of a physical (PHY) layer. Specific implementations of the base stations 120 are not limited in the examples of the disclosure.

The base stations 120 are in radio connection with the user equipment 110 through a wireless air interface. In different implementations, the wireless air interface is based on a standard of the 4th generation mobile communication (4G), or a standard of the 5th generation mobile communication (5G), and is a new radio, for example. Alternatively, the wireless air interface may also be based on a standard of a next generation mobile communication following 5G.

In some examples, an end to end (E2E) connection may also be established between the user equipment 110. For example, scenarios such as vehicle to vehicle (V2V) communication, vehicle to infrastructure (V2I) communication, and vehicle to pedestrian (V2P) communication in vehicle to everything (V2X) communication are provided.

The user equipment described above may be deemed as a terminal device in the following examples here.

In some examples, the radio communication system described above may further encompass a network management device 130.

Each of several base stations 120 is connected to the network management device 130. The network management device 130 may be a core network device in the radio communication system. For example, the network management device 130 may be a mobility management entity (MME) in an evolved packet core (EPC). Alternatively, the network management device may also be another core network device, such as a serving gateway (SGW), a public data network gateway (PGW), a policy and charging rules function (PCRF), a home subscriber server (HSS), etc. An implementation form of the network management device 130 is not limited in the examples of the disclosure.

In the standard discussion of new radio based unlicensed access (NR-U), clear channel assessment (CCA) is usually performed to evaluate interference of a channel before a sending end sends data. If the interference is lower than a threshold, the channel is deemed clear, and the sending end may occupy the channel to send the data. If the interference is higher than the threshold, the channel is deemed busy, and the sending end may not occupy the channel to send data.

The CCA method described above may not solve hidden nodes in unlicensed spectrum communication. As shown in FIG. 2, a sending end TX1 will send data to a receiving end RX1. TX1 will perform CCA before sending the data. In this case, a receiving end TX2 is sending data to a sending end RX2, and a data sending signal will cause interference to data receiving by RX1. However, since TX1 is far away from TX2, when TX1 performs the CCA, the interference from TX2 will not be assessed, and thus TX1 will occupy a channel to send the data to RX1. In this case, data receiving by RX1 undergoes strong interference from data sending by TX2 which is a hidden node for TX1.

In order to solve the hidden node in uplink transmission, an existing solution is as follows: a base station performs CCA before UE starts uplink transmission, and sends a backoff signal when channel assessment interference is low. After assessing the backoff signal, a surrounding node will not send data. If the backoff signal encompasses a cell identity (ID), the UE may determine that reception interference at a base station side is low after receiving the backoff signal, and send data.

Moreover, in the standard of NR-U, a configured grant-physical uplink shared channel (CG-PUSCH) is employed for transmission, that is, transmission resources of a periodic physical uplink shared channel (PUSCH) in a time domain are configured through radio resource control (RRC) signaling. During enhancement of a CG-PUSCH in R16, the CG-PUSCH is added with an expansion of N slots, where N is a positive integer greater than or equal to 1. The expansion of N slots is to transmit different uplink data over N consecutive slots. As shown in FIG. 3, CG-PUSCH 1, CG-PUSCH 2, CG-PUSCH 3, and CG-PUSCH 4 are CG-PUSCHs over the N expanded slots, and have the same symbol positions in each slot. In one example, CG-PUSCH 1, CG-PUSCH 2, CG-PUSCH 3, and CG-PUSCH 4 may not occupy entire slots necessarily. In another example, CG-PUSCH 1, CG-PUSCH 2, CG-PUSCH 3, and CG-PUSCH 4 may also occupy the entire slots.

Disclosed in the examples of the disclosure are a processing method and apparatus for increasing uplink coverage, a communication device, and a storage medium.

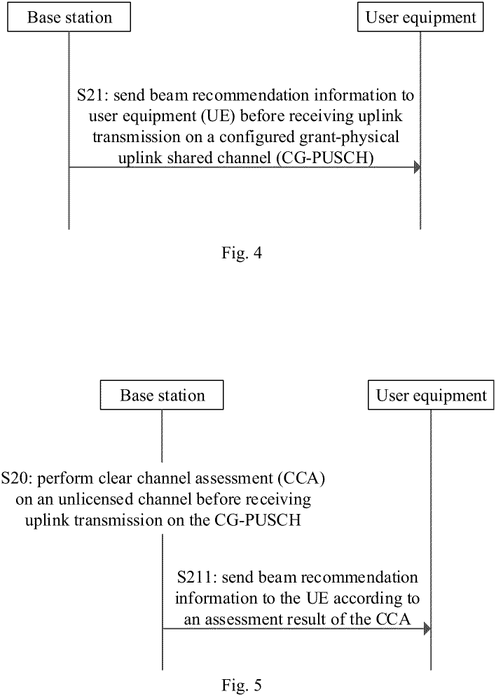

As shown in FIG. 4, provided in the example is a data transmission processing method. The method is applied to a base station and includes:

Step S21: beam recommendation information is sent to user equipment (UE) before receiving uplink transmission on a configured grant-physical uplink shared channel (CG-PUSCH);

where the beam recommendation information at least indicates: one or more recommended beams; and the recommended beams may be selected by the UE to perform uplink transmission on the CG-PUSCH.

The recommended beam here may be a beam recommended or suggested by the base station to the UE to perform uplink transmission on the CG-PUSCH. The UE may select the recommended beam for communication according to the beam recommendation information, or a beam other than the recommended beam for communication.

Here, the base station is an interface device for the user equipment to access the Internet. The base station may be any one of various types of base stations, such as a 3G base station, a 4G base station, a 5G base station, or another evolved node B (eNB).

Here, the user equipment (UE) may be a mobile phone, a computer, a server, a transceiver device, a tablet device or a medical device, etc.

The uplink transmission of the user equipment uses a sending beam, and the base station receives the uplink transmission of a terminal through a receiving beam.

Before issuing the beam recommendation information, the base station may perform CCA on the receiving beam for receiving the uplink transmission, and then send the beam recommendation information to the terminal according to a corresponding relation between the sending beam and the receiving beam, so as to ensure that the recommended beam is a beam capable of ensuring a quality of the uplink transmission.

The technical solutions provided in the examples of the disclosure can have the beneficial effects as follows:

in the examples of the disclosure, the beam recommendation information is sent to the user equipment before receiving the uplink transmission on the configured grant-physical uplink shared channel, where the beam recommendation information at least indicates one or more recommended beams; and the recommended beams may be selected by the UE to perform the uplink transmission on the CG-PUSCH. Thus, in the examples of the disclosure, the base station may recommend the recommended beam to perform the uplink transmission on the CG-PUSCH to the UE before the UE performs the uplink transmission on the CG-PUSCH. In this way, the UE may perform the uplink transmission on the CG-PUSCH on the basis of the recommended beam recommended by the base station, instead of performing the uplink transmission on the CG-PUSCH on the basis of a blindly selected beam, and thus the quality of uplink communication may be ensured.

In one example, the recommended beam is a recommended sending beam, and the recommended sending beam may be selected by the UE to perform uplink transmission on the CG-PUSCH.

In some examples, the recommended beam is one or more of a plurality of beams configured on the CG-PUSCH to perform uplink transmission.

In one example, the recommended beam is one or more of a plurality of sending beams configured on the CG-PUSCH to perform uplink transmission.

In this way, in the examples of the disclosure, if a UE side is configured with a plurality of beams, the recommended beam is one or more of the beams configured on the CG-PUSCH.

In the example of the disclosure, if there are a plurality of recommended beams, the UE may use one or more recommended beams to perform uplink transmission on the CG-PUSCH.

In some examples, the recommended beam is a sending beam, corresponding to a receiving beam undergoing minimum interference from the CCA of the base station, of the UE.

In this way, in the examples of the disclosure, the sending beam corresponding to the receiving beam undergoing the minimum interference may be used to perform the uplink transmission on the CG-PUSCH, thus improving the communication quality of the uplink transmission as much as possible.

In one example, as shown in FIG. 3, there may be four CG-PUSCHs in one CG-PUSCH transmission cycle. For example, they may be CG-PUSCH 1, CG-PUSCH 2, CG-PUSCH 3, and CG-PUSCH 4, respectively.

Here, one CG-PUSCH may occupy all or part of symbols of one slot. For example, CG-PUSCH 1 may occupy all symbols of a 0th slot, or 3rd to 4th symbols of the 0th slot.

In the examples of the disclosure, the base station may recommend the recommended beam to perform the uplink transmission on the CG-PUSCH to the UE before the UE performs the uplink transmission on the CG-PUSCH, so that the UE knows which beam or beams may be used to perform uplink transmission on the CG-PUSCH. In this way, the UE may perform the uplink transmission on the CG-PUSCH on the basis of the recommended beam recommended by the base station, instead of performing the uplink transmission on the CG-PUSCH on the basis of a blindly selected beam, and thus the quality of uplink communication may be ensured.

In some application scenarios, if a backoff signal received by the UE does not carry identifier information of the base station, the UE will not send uplink data. If a backoff signal received by the UE carries identifier information of the base station, the UE will send uplink data.

In some examples, the beam recommendation information is carried in a backoff signal sent by the base station.

Here, the backoff signal carries the identifier information of the base station. In this way, after the UE receives the backoff signal, if the backoff signal carries the identifier information of the serving base station of the UE, the uplink transmission may be performed on the CG-PUSCH on the basis of the recommended beam in the beam recommendation information.

In this way, one backoff signal may inform the UE whether to perform the uplink transmission, and also inform the UE which beam or beams should be used to perform the uplink transmission when the uplink transmission is needed. In this way, one backoff signal may have two different functions, and thus saves on signaling overhead.

In some application scenarios, when the beam recommendation information is carried in the backoff signal, the backoff signal may be broadcast, so that adjacent surrounding nodes may avoid sending information, and the UE may obtain the beam recommendation information after receiving the backoff signal.

Certainly, in other examples, the step that beam recommendation information is sent to user equipment (UE) includes: the beam recommendation information is broadcasting, or sent on the basis of RRC signaling.

In some application scenarios, the beam recommendation information may be sent to a plurality of pieces of UE in a broadcast manner. A CG-PUSCH of the plurality of pieces of UE is a common channel. In this way, a plurality of pieces of UE in an entire cell may receive the beam recommendation information at the same time, so that signaling overhead caused by sending the beam recommendation information to each UE separately may be reduced.

In some other application scenarios, RRC signaling may be used for sending the beam recommendation information to certain specific UE or a certain group of specific UE, so as to reduce radio interference, caused by broadcasting the beam recommendation information, to the entire cell.

As shown in FIG. 5, in some examples, the method further includes:

Step S20: clear channel assessment (CCA) is performed on an unlicensed channel before receiving the uplink transmission on the CG-PUSCH; where

the step that beam recommendation information is sent to user equipment (UE) includes:

Step S211: the beam recommendation information is sent to the UE according to an assessment result of the CCA.

In some examples, the step that clear channel assessment (CCA) is performed on an unlicensed channel includes:

the CCA is performed on a plurality of receiving beams on the unlicensed channel; where the receiving beam is a receiving beam for receiving the uplink transmission on the CG-PUSCH.

Here, the receiving beam, for receiving the uplink transmission on the CG-PUSCH, of the base station corresponds to the sending beam, for sending the uplink transmission on the CG-PUSCH, of the user equipment.

In some application scenarios, a plurality of receiving beams of the base station correspond to a plurality of sending beams of the UE, respectively. A corresponding relation may be that one sending beam corresponds to one receiving beam, or a plurality of receiving beams.

Here, the corresponding relation between the sending beam and the receiving beam may be preset in the base station.

Here, the corresponding relation may be obtained on the basis of beam training. The beam training is a process of predetermining the corresponding relation between the sending beam and the receiving beam through a beam transceiving effect.

For example, the plurality of sending beams for the UE may be numbered as sending beam 1, sending beam 2, ... sending beam H, respectively. The plurality of receiving beams for the base station may be numbered as receiving beam 1, receiving beam 2, ... receiving beam L, respectively; where H and L are both positive integers greater than or equal to 2.

In the beam training process, if at the UE side, data are sent on the basis of sending beam 1. At the base station side, it is determined that sending beam 1 and receiving beam 1 are in a corresponding relation if the effect of receiving data on the basis of receiving beam 1 is the best.

Alternatively,

If at the UE side, data are sent on the basis of sending beam 1, and at the base station side, the effect of receiving data on the basis of receiving beam 2 or receiving beam 3 are both desirable, it is determined that sending beam 1 and receiving beam 2 and receiving beam 3 are in a corresponding relation.

In the examples of the disclosure, the CCA may be performed on the receiving beam of the base station to determine whether interference generated when the receiving beam receives the uplink transmission on the CG-PUSCH is greater than a threshold. The receiving beam is determined as a non-clear receiving beam if the interference is greater than or equal to the threshold.

The receiving beam is determined as a clear receiving beam if the interference is lower than the threshold. A sending beam corresponding to the clear receiving beam is determined on the basis of a corresponding relation between the receiving beam of the base station and the sending beam of the UE, and the sending beam is a recommended beam.

Here, the threshold may be specified in a communication protocol or preset in the base station.

In this way, in the examples of the disclosure, the clear receiving beam may be obtained by performing the CCA on the receiving beam of the base station, so that the corresponding sending beam may be determined on the basis of the clear receiving beam to perform recommendation, and the UE may perform the uplink transmission on the CG-PUSCH on the basis of its own sending beam. Moreover, in the examples of the disclosure, the base station performs the CCA on the receiving beam, thus greatly reducing the influence, from strong interference of the hidden node, on the uplink transmission by the UE, and further improving the quality of the uplink transmission by the UE.

In some examples, step S211 includes:

in response to determining that there is at least one clear beam on the basis of the assessment result of the CCA, the beam recommendation information is sent to the UE.

In some examples, the step that in response to determining that there is at least one clear beam on the basis of the assessment result of the CCA, the beam recommendation information is sent to the UE includes:

in response to determining that there is at least one clear receiving beam on the basis of the assessment result of the CCA, beam recommendation information of the sending beam corresponding to the clear receiving beam is sent to the UE.

Here, if it is determined that interference of one receiving beam is lower than the threshold on the basis of the assessment result of the CCA, the one receiving beam is determined as the clear beam, and beam recommendation information of a sending beam corresponding to the one clear beam is determined to be sent to the UE.

Alternatively, if it is determined that interference of a plurality of receiving beams is lower than the threshold on the basis of the assessment result of the CCA, the plurality of receiving beams are all determined as clear beams, and beam recommendation information of sending beams corresponding to the plurality of clear beams is determined to be to the UE.

In this way, in the examples of the disclosure, the sending beam to perform uploading on the CG-PUSCH may be recommended to the UE on the basis of the assessment result of the CCA. In this way, when the UE sends data on the basis of the sending beam or the sending beams, the undergone interference is low, so that the quality of the uplink transmission is ensured.

Moreover, in the case of being based on the CCA, that is, in the case of employing the receiving end to perform the CCA, compared with the related art in which when the sending end performs CCA, the probability of a poor communication quality caused by the hidden node positioned close to the base station and away from the user equipment may be greatly reduced. For example, as in FIG. 2, the hidden node, relative to TX1, of TX2 has the influence of strong interference on data receiving by RX1.

Here, after the clear receiving beam is determined, the beam recommendation information is sent according to the corresponding relation between the receiving beam and the sending beam, the recommended beam indicated in the beam recommendation information being one or more sending beams corresponding to the clear receiving beam.

In this way, in the examples of the disclosure, the sending beam may be recommended to the UE on the basis of the assessment result, so that the UE may undergo low interference when performing the uplink transmission on the CG-PUSCH on the basis of the sending beam recommended by the base station, and the quality of the uplink transmission is ensured.

In some other examples, step S211 includes:

in response to determining that there is no clear beam on the basis of the assessment result of the CCA, sending of the beam recommendation information is stopped.

In the examples of the disclosure, if it is determined that no beam is a clear beam on the basis of the assessment result of the CCA, it indicates that channels around the base station are all busy, and it is determined that the base station does not send the beam recommendation information to the UE.

In this way, in the examples of the disclosure, the situation that the non-clear beam of the base station leads to the poor communication quality of the uplink transmission may be reduced.

In some examples, step S20 includes:
CCA is performed on the unlicensed channel before receiving uplink transmission on each CG-PUSCH; and
alternatively,
CCA is performed on the unlicensed channel before receiving uplink transmission on every N CG-PUSCHs; where N is a positive integer greater than or equal to 2.

For example, as shown in FIG. 3, the base station may perform CCA on the unlicensed channel before receiving uplink transmission on CG-PUSCH 1, and send beam recommendation information according to an assessment result of the CCA. Moreover, the base station may also perform CCA on a unlicensed channel before receiving uplink transmission on CG-PUSCH 2, and send beam recommendation information according to an assessment result of the CCA. Similarly, the base station performs CCA on the unlicensed channel before receiving uplink transmission on CG-PUSCH 3 and CG-PUSCH 4, and sends beam recommendation information according to an assessment result of the CCA.

In the examples described above, CG-PUSCH 1, CG-PUSCH 2, CG-PUSCH 3, and CG-PUSCH 4 are four expansions of the CG-PUSCH in one cycle.

For example, as shown in FIG. 3, the base station may perform CCA on the unlicensed channel before receiving uplink transmission on every N CG-PUSCHs. For example, if N is equal to 2, the base station may perform CCA on the unlicensed channel before receiving uplink transmission on CG-PUSCH 1, and send beam recommendation information according to an assessment result of the CCA; and CG-PUSCH 1 and CG-PUSCH 2 perform the uplink transmission on the basis of a recommended beam indicated in the beam recommendation information. The base station performs CCA on the unlicensed channel before receiving the uplink transmission on CG-PUSCH 3, and sends beam recommendation information according to an assessment result of the CCA; and CG-PUSCH 3 and CG-PUSCH 4 perform the uplink transmission on the basis of a recommended beam indicated in the beam recommendation information.

Moreover, if N is equal to 4, the base station may perform CCA on the unlicensed channel before receiving the uplink transmission on CG-PUSCH 1, and send beam recommendation information according to an assessment result of the CCA; and CG-PUSCH 1, CG-PUSCH 2, CG-PUSCH 3, and CG-PUSCH 4 perform the uplink transmission on the basis of a recommended beam indicated in the beam recommendation information. The base station performs CCA on the unlicensed channel before receiving uplink transmission on CG-PUSCH 5, and sends beam recommendation information according to an assessment result of the CCA; and CG-PUSCH 5, CG-PUSCH 6, CG-PUSCH 7, and CG-PUSCH 8 perform the uplink transmission on the basis of a recommended beam indicated in the beam recommendation information.

In one example, time-frequency resources corresponding to the N CG-PUSCHs are in one cycle.

In another example, time-frequency resources corresponding to the N CG-PUSCHs are in a plurality of cycles.

In the examples of the disclosure, the CCA may be performed on the unlicensed channel before receiving the uplink transmission on each CG-PUSCH. In this way, whether the channel is clear may be assessed in time before receiving the uplink transmission on each CG-PUSCH. Thus, the recommended beam obtained on the basis of the assessment result may further improve the quality of the uplink transmission.

Alternatively, the CCA is performed on the unlicensed channel before receiving the uplink transmission on every N CG-PUSCHs. In this way, whether the channel is clear may be assessed in time before performing the uplink transmission on every N CG-PUSCHs. Thus, the recommended beam obtained on the basis of the assessment result may greatly reduce the number of times that the base station sends the beam recommendation information to the UE, and save on resource overhead for sending the beam recommendation information while ensuring the quality of the uplink transmission.

In some examples, the method further includes:

indicator information is sent to the UE, where the indicator information is used for indicating the number of CG-PUSCHs on which the UE sends the uplink transmission on the basis of the recommended beam.

In this way, in the examples of the disclosure, the base station may issue the indicator information to the UE to inform the UE of the number of CG-PUSCHs applicable to the recommended beam to perform the uplink transmission.

In one example, the step that indicator information is sent to the UE includes:

A system message carrying the indicator information is broadcast.

In this way, in the examples of the disclosure, the indicator information may be sent to a plurality of pieces of UE in the cell at the same time in a broadcast manner, thus reducing signaling overhead.

In another example, the step that indicator information is sent to the UE includes:

RRC signaling is issued to the UE, where the RRC signaling carries the indicator information.

In this way, in the examples of the disclosure, the indicator information may be sent to certain UE or certain pieces of UE in the cell through high layer signaling RRC, thus reducing radio interference to other UE in the cell.

Certainly, in other examples, the number of CG-PUSCHs on which the UE performs the uplink transmission on the basis of the recommended beam may also be specified in the communication protocol.

Certainly, in other examples, the step that indicator information is sent to the UE may also be that the indicator information is carried in the beam recommendation information to be sent. In this way, sending of signaling may be further reduced.

In some examples, step S20 includes:

CCA is performed on the unlicensed channel at a predetermined time domain position before receiving the uplink transmission on the CG-PUSCH.

In the examples of the disclosure, an assessment time for performing CCA on a unlicensed channel is the predetermined time domain position before receiving the uplink transmission on the CG-PUSCH. In this way, in one aspect, the CCA is ensured to be pre-performed on the unlicensed channel, so that the base station may recommend the beam for the uplink transmission to the UE on the basis of the assessment result of the CCA. In another aspect, since the assessment time of the CCA and the time for performing the uplink transmission are in the predetermined time domain position and both short, so that the assessment result of the CCA may truly reflect whether the channel is clear, and the beam recommended on be basis of the assessment result may improve the quality of the uplink transmission.

For example, the situation that when the channel is clear during the CCA, but the UE actually performs uplink transmission on the basis of the channel; and after the channel is occupied by other nodes to become a non-clear channel, the communication quality is poor if the UE still performs the uplink transmission on the basis of the channel may be reduced.

In some examples, the predetermined time domain position includes: M time domain units, the time domain unit including a symbol or a mini-slot, and M being a positive integer greater than or equal to 1.

In one example, M is less than or equal to 14.

In this way, in the examples of the disclosure, the CCA may be performed on the unlicensed channel before M symbols or M mini-slots of receiving the uplink transmission on the CG-PUSCH. In this way, the CCA may be performed shortly before the UE sends the uplink transmission, thus obtaining a more accurate assessment result of the CCA.

In some other examples, the predetermined time domain position includes P time domain units, the time domain unit including a slot, and P being less than M.

In one example, P is a positive integer less than or equal to 3.

In this way, in the examples of the disclosure, the CCA may be performed on the unlicensed channel on any one of M time domain units before receiving the uplink transmission on the CG-PUSCH. In this way, the CCAmay also be performed shortly before sending the uplink transmission, thus obtaining a more accurate assessment result of the CCA.

Certainly, in some application scenarios, the predetermined time domain position may include one of a symbol, a mini-slot, and a slot. In this way, an interval between the assessment time of the CCA on the unlicensed channel and time for performing the uplink transmission on the CG-PUSCH may be shorter, so as to more truly reflect whether the channel is clear during the uplink transmission on the CG-PUSCH, thus obtaining a more accurate assessment result of the CCA.

In some examples, the step that beam recommendation information is sent to user equipment (UE) includes: the beam recommendation information is sent to the UE at Q time domain units before receiving the uplink transmission on the CG-PUSCH.

Here, the time domain unit includes a symbol or a mini-slot; and Q is a positive integer greater than or equal to 1.

In one example, Q is less than M.

In this way, in the examples of the disclosure, the beam recommendation information may be sent to the UE in time, so that the UE performs the uplink transmission on the CG-PUSCH on the basis of the clear beam, thus ensuring the communication quality of the uplink transmission.

Certainly, in other examples, the step that beam recommendation information is sent to UE may also be that the beam recommendation information is sent to the UE on a periodically configured channel closest to the time domain unit at which the UE performs the uplink transmission before receiving the uplink transmission on the CG-PUSCH. For example, the periodically configured channel may be a periodically configured downlink control channel, a broadcast channel, etc. In this way, the beam recommendation information may also be sent to the UE in time, so that the UE may perform the uplink transmission on the CG-PUSCH on the basis of the clear beam, thus ensuring the communication quality of the uplink transmission.

It should be noted that the following data transmission processing method is applied to user equipment, which is similar to the description of the data transmission processing method described above applied to the base station. For the technical details not disclosed in the examples of the data transmission processing method applied to the user equipment in the disclosure, reference may be made to the description of the examples of the data transmission processing method applied to the base station in the disclosure, which will not be described in detail here.

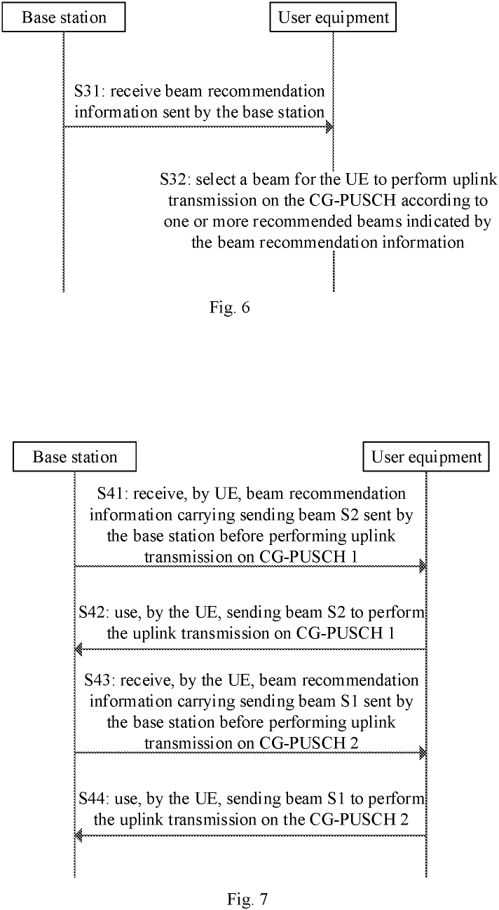

As shown in FIG. 6, provided is a data transmission processing method. The method is applied to user equipment (UE) and includes:

Step S31: beam recommendation information sent by a base station is received;

where the beam recommendation information is sent by the base station before receiving uplink transmission on a configured grant-physical uplink shared channel (CG-PUSCH); and

step S32: a beam is selected for the UE to perform uplink transmission on the CG-PUSCH according to one or more recommended beams indicated by the beam recommendation information.

In some examples, the recommended beam is one or more of a plurality of beams configured on the CG-PUSCH to perform uplink transmission.

In some examples, the beam recommendation information is determined by the base station on the basis of an assessment result obtained by performing clear channel assessment (CCA) on an unlicensed channel; and the CCA is performed before receiving the uplink transmission on the CG-PUSCH.

In some examples, the base station performs the CCA on a plurality of receiving beams on the unlicensed channel; where the receiving beam is a receiving beam for receiving the uplink transmission on the CG-PUSCH.

In some examples, step S31 includes:

the beam recommendation information sent by the base station after determining that there is at least one clear beam on the basis of the assessment result of the CCA is received.

In some examples, the CCA is performed on the unlicensed channel before receiving uplink transmission on each CG-PUSCH; and
alternatively,
the CCA is performed on the unlicensed channel before receiving uplink transmission on every N CG-PUSCHs; where N is a positive integer greater than or equal to 2.

In some examples, the CCA is performed on the unlicensed channel at a predetermined time domain position before receiving the uplink transmission on the CG-PUSCH.

In some examples, the predetermined time domain position includes: M time domain units, the time domain unit including a symbol or a mini-slot, and M being a positive integer greater than or equal to 1.

In some examples, the beam recommendation information is carried in a backoff signal sent by the base station.

In some examples, the recommended beam is a sending beam, corresponding to a receiving beam undergoing minimum interference from the CCA of the base station, of the UE.

In order to facilitate an understanding of the examples described above of the disclosure, the following instances are described illustratively here.

### Instance 1

As shown in FIG. 3, one cycle includes 10 slots. N CG-PUSCHs are expanded in one cycle, where N is equal to 4. In a first cycle, four CG-PUSCHs are CG-PUSCH 1, CG-PUSCH 2, CG-PUSCH 3, and CG-PUSCH 4, respectively.

The base station configures two sending beams for the CG-PUSCH configured on the user equipment, that is, two uplink sounding reference signal resource indicators (srs-Resource Indicators) are configured. The two sending beams are sending beam S1 and sending beam S2, respectively.

As shown in FIG. 7, provided in an example of the disclosure is a data processing method. The method includes:

Step S41: UE receives beam recommendation information carrying sending beam S2 sent by a base station before performing uplink transmission on CG-PUSCH 1.

Step S42: the UE uses sending beam S2 to perform the uplink transmission on CG-PUSCH 1.

Step S43: the UE receives beam recommendation information carrying sending beam S1 sent by the base station before performing uplink transmission on CG-PUSCH 2.

Step S44: the UE uses sending beam S1 to perform the uplink transmission on the CG-PUSCH 2.

In this way, in the example of the disclosure, the UE may receive the recommended beam information sent by the base station before performing uplink transmission on each CG-PUSCH, and perform the uplink transmission on the corresponding CG-PUSCH on the basis of the sending beam carried in the recommended beam information.

### Instance 2

As shown in FIG. 3, one cycle includes10 slots. N CG-PUSCHs are expanded in one cycle, where N is equal to 4. In a first cycle, four CG-PUSCHs are CG-PUSCH 1, CG-PUSCH 2, CG-PUSCH 3, and CG-PUSCH 4, respectively. In a second cycle, four CG-PUSCHs are CG-PUSCH 5, CG-PUSCH 6, CG-PUSCH 7, and CG-PUSCH 8, respectively.

The base station configures four sending beams for the CG-PUSCHs configured on the user equipment, that is, four uplink sounding reference signal resource indicators (srs-Resource Indicators) are configured. The four sending beams are sending beam S1, sending beam S2, sending beam S3, and sending beam S4, respectively.

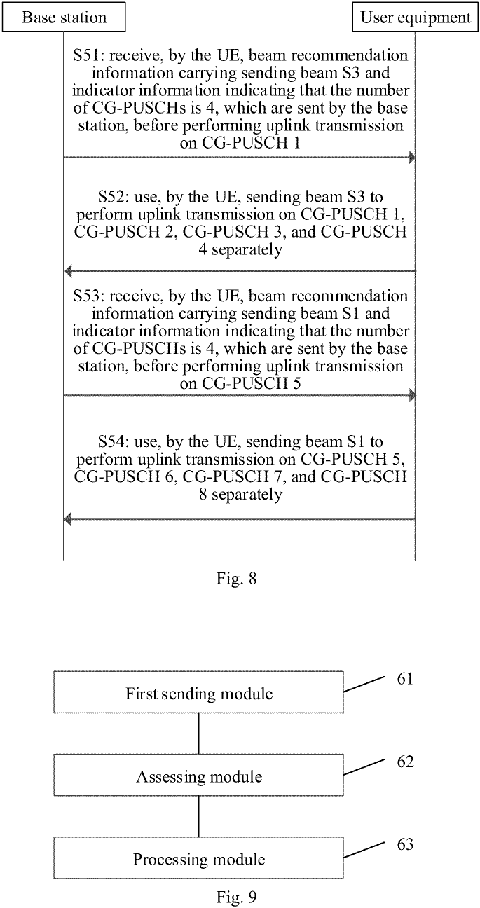

As shown in FIG. 8, provided in an example of the disclosure is a data processing method. The method includes:

Step S51: UE receives beam recommendation information carrying sending beam S3 and indicator information indicating that the number of CG-PUSCHs is 4, which are sent by a base station, before performing uplink transmission on CG-PUSCH 1.

Step S52: the UE uses sending beam S3 to perform uplink transmission on CG-PUSCH 1, CG-PUSCH 2, CG-PUSCH 3, and CG-PUSCH 4 separately.

Step S53: the UE receives beam recommendation information carrying sending beam S1 and indicator information indicating that the number of CG-PUSCHs is 4, which are sent by the base station, before performing uplink transmission on CG-PUSCH 5.

Step S54: the UE uses sending beam S1 to perform uplink transmission on CG-PUSCH 5, CG-PUSCH 6, CG-PUSCH 7, and CG-PUSCH 8 separately.

In this way, in the example of the disclosure, the UE may receive the recommended beam information and the indicator information indicating the number of CG-PUSCHs, which are sent by the base station, before performing uplink transmission on every four CG-PUSCHs, and perform the uplink transmission on the four corresponding CG-PUSCHs on the basis of the sending beam carried in the recommended beam information.

As shown in FIG. 9, provided in an example of the disclosure is a data transmission processing apparatus. The apparatus is applied to a base station and includes:

a first sending module 61 configured for sending beam recommendation information to user equipment (UE) before receiving uplink transmission on a configured grant-physical uplink shared channel (CG-PUSCH);

where the beam recommendation information at least indicates: one or more recommended beams; and the recommended beams may be selected by the UE to perform uplink transmission on the CG-PUSCH.

In some examples, the recommended beam is one or more of a plurality of beams configured on the CG-PUSCH to perform uplink transmission.

In some examples, the apparatus further includes:
an assessing module 62 configured for performing clear channel assessment (CCA) on an unlicensed channel before receiving the uplink transmission on the CG-PUSCH; where
the first sending module 61 is configured for sending the beam recommendation information to the UE according to an assessment result of the CCA.

In some examples, the assessing module 62 is configured for performing the CCA on a plurality of receiving beams on the unlicensed channel; where the receiving beam is a receiving beam for receiving the uplink transmission on the CG-PUSCH.

In some examples, the first sending module 61 is configured for in response to determining that there is at least one clear beam on the basis of the assessment result of the CCA, sending the beam recommendation information to the UE.

In some examples, the apparatus further includes:

a processing module 63 configured for in response to determining that there is no clear beam on the basis of the assessment result of the CCA, stopping sending the beam recommendation information.

In some examples, the assessing module 62 is configured for performing CCA on the unlicensed channel before receiving uplink transmission on each CG-PUSCH; and

alternatively,

the assessing module is configured for performing CCA on the unlicensed channel before receiving uplink transmission on every N CG-PUSCHs; where N is a positive integer greater than or equal to 2.

In some examples, the assessing module 62 is configured for performing CCA on the unlicensed channel at a predetermined time domain position before receiving the uplink transmission on the CG-PUSCH.

In some examples, the predetermined time domain position includes: M time domain units, the time domain unit including a symbol or a mini-slot, and M being a positive integer greater than or equal to 1.

In some examples, the beam recommendation information is carried in a backoff signal sent by the base station.

In some examples, the recommended beam is a sending beam, corresponding to a receiving beam undergoing minimum interference from the CCA of the base station, of the UE.

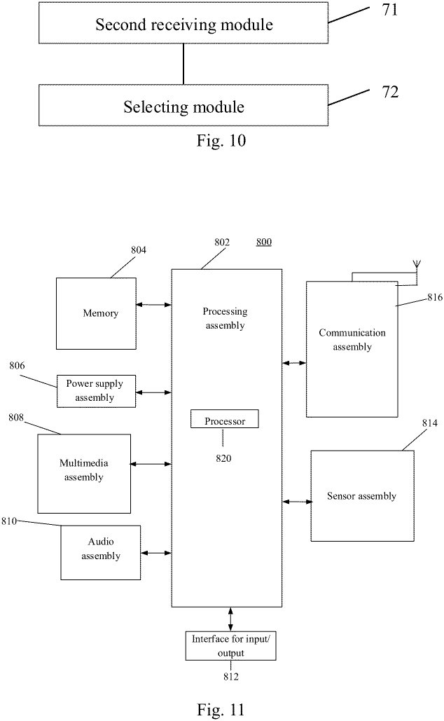

As shown in FIG. 10, provided in an example of the disclosure is a data transmission processing apparatus. The apparatus is applied to user equipment (UE) and includes:
a second receiving module 71 configured for receiving beam recommendation information sent by a base station; where the beam recommendation information is sent by the base station before receiving uplink transmission on a configured grant-physical uplink shared channel (CG-PUSCH); and
a selecting module 72 configured for selecting a beam for the UE to perform uplink transmission on the CG-PUSCH according to one or more recommended beams indicated by the beam recommendation information.

In some examples, the recommended beam is one or more of a plurality of beams configured on the CG-PUSCH to perform uplink transmission.

In some examples, the beam recommendation information is determined by the base station on the basis of an assessment result obtained by performing clear channel assessment (CCA) on an unlicensed channel; and the CCA is performed before receiving the uplink transmission on the CG-PUSCH.

In some examples, the base station performs the CCA on a plurality of receiving beams on the unlicensed channel; where the receiving beam is a receiving beam for receiving the uplink transmission on the CG-PUSCH.

In some examples, the second receiving module 71 is configured for receiving the beam recommendation information sent by the base station after determining that there is at least one clear beam on the basis of the assessment result of the CCA.

In some examples, the CCA is performed on the unlicensed channel before receiving uplink transmission on each CG-PUSCH; and

alternatively,

the CCA is performed on the unlicensed channel before receiving uplink transmission on every N CG-PUSCHs; where N is a positive integer greater than or equal to 2.

In some examples, the CCA is performed on the unlicensed channel at a predetermined time domain position before receiving the uplink transmission on the CG-PUSCH.

In some examples, the predetermined time domain position includes: M time domain units, the time domain unit including a symbol or a mini-slot, and M being a positive integer greater than or equal to 1.

In some examples, the beam recommendation information is carried in a backoff signal sent by the base station.

In some examples, the recommended beam is a sending beam, corresponding to a receiving beam undergoing minimum interference from the CCA of the base station, of the UE.

With respect to the apparatus in the example described above, specific ways in which various modules execute operations have been described in detail in the examples relating to the method, and will not be described in detail here.

Provided in an example of the disclosure is a communication device. The communication device includes:
a processor; and
a memory used for storing an executable instruction of the processor;
where the processor is configured for implementing the data transmission processing method in any example of the disclosure when running the executable instruction.

Here, the communication device includes a base station or user equipment.

The memory may include various types of storage media. The storage media are non-transitory computer storage media that may continue to remember information stored after the communication device is powered off. Here, the communication device includes a base station or user equipment.

The processor may be connected to the memory through a bus, etc. for reading the executable program stored on the memory, for example, at least one of the methods shown in FIGS. 4-8.

Further provided in examples of the disclosure is a non-transitory computer storage medium, storing a computer executable program, where the executable program implements the data transmission processing method in any example of the disclosure when executed by a processor. For example, at least one of the methods shown in FIGS. 4-8.

With respect to the apparatus in the example described above, specific ways in which various modules execute operations have been described in detail in the examples relating to the method, and will not be described in detail here.

FIG. 11 is a block diagram of user equipment (UE) 800 according to an example. For example, the user equipment 800 may be a mobile phone, a computer, a digital broadcast terminal, a messaging device, a gaming console, a tablet device, a medical device, a fitness device, a personal digital assistant, etc.

With reference to FIG. 11, the user equipment 800 may include one or more of the following assemblies: a processing assembly 802, a memory 804, a power supply assembly 806, a multimedia assembly 808, an audio assembly 810, an interface 812 for input/output (I/O), a sensor assembly 814, and a communication assembly 816.

The processing assembly 802 generally controls overall operation of the user equipment 800, for example, operations associated with display, phone calls, data communication, camera operations, and recording operations. The processing assembly 802 may include one or more processors 820, to execute instructions, so as to complete all or some of steps of the methods described above. In addition, the processing assembly 802 may include one or more modules that facilitate interaction between the processing assembly 802 and other assemblies. For example, the processing assembly 802 may include a multimedia module, to facilitate interaction between the multimedia assembly 808 and the processing assembly 802.

The memory 804 is configured for storing various types of data, to support operations at the user equipment 800. Instances of such data include an instruction, operated on the user equipment 800, for any application or method, contact data, phonebook data, messages, pictures, video, etc. The memory 804 may be implemented through any type or combination of volatile or non-volatile memory devices, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply assembly 806 provides power for various assemblies of the user equipment 800. The power supply assembly 806 may include a power supply management system, one or more power supplies, and other assemblies associated with power generation, management, and distribution for the user equipment 800.

The multimedia assembly 808 includes a screen that provides an output interface between the user equipment 800 and a user. In some examples, the screen may include a liquid crystal display (LCD) and a touch panel (TP). If the screen includes a touch panel, the screen may be implemented as a touch screen, so as to receive an input signal from the user. The touch panel includes one or more touch sensors, to sense touches, swipes, and gestures on the touch panel. Except for sensing a boundary of a touch or swipe action, the touch sensor may also detect a duration and a pressure associated with a touch or swipe operation. In some examples, the multimedia assembly 808 includes a front facing camera and/or a rear facing camera. When the user equipment 800 is in an operation mode, such as a photographing mode or a video mode, the front-facing camera and/or the rear-facing camera may receive external multimedia data. Each of the front-facing camera and the rear-facing camera may be a fixed optical lens system or have a focal length and an optical zoom capacity.

The audio assembly 810 is configured for outputting and/or inputting audio signals. For example, the audio assembly 810 includes a microphone (MIC) configured for receiving an external audio signal when the user equipment 800 is in operation modes, such as a call mode, a recording mode, and a voice recognition mode. The received audio signal may be further stored in the memory 804 or sent via the communication assembly 816. In some examples, the audio assembly 810 further includes a speaker for outputting the audio signal.

The interface 812 for I/O provides an interface between the processing assembly 802 and a peripheral interface module such as a keyboard, a click wheel, a button, etc. These buttons may include, but are not limited to: a home button, a volume button, a start button, and a lock button.

The sensor assembly 814 includes one or more sensors for providing state assessments of various aspects for the user equipment 800. For example, the sensor assembly 814 may detect an on/off state of the equipment 800 and relative positioning of the assemblies. For example, the assemblies are a display and a keypad of the user equipment 800. The sensor assembly 814 may also detect a change in position of the user equipment 800 or one assembly of the user equipment 800, the presence or absence of contact between the user and the user equipment 800, orientation or acceleration/deceleration of the user equipment 800, and temperature variation of the user equipment 800. The sensor assembly 814 may include a proximity sensor configured for detecting the presence of a nearby object in the absence of any physical contact. The sensor assembly 814 may further include a light sensor, such as a complementary metal oxide semiconductor (CMOS) or a charged coupled device (CCD) image sensor for imaging applications. In some examples, the sensor assembly 814 may further include an acceleration sensor, a gyroscopic sensor, a magnetic sensor, a pressure sensor, or a temperature sensor.

The communication assembly 816 is configured for facilitating communication between the user equipment 800 and other devices in a wired or wireless mode. The user equipment 800 may access a wireless network based on a communication standard, for example, wireless fidelity (WiFi), 2G, or 3G, or their combination. In one example, the communication assembly 816 receives a broadcast signal or broadcast related information from an external broadcast management system by means of a broadcast channel. In one example, the communication assembly 816 further includes a near field communication (NFC) module to facilitate short-range communication. For example, the NFC module may be implemented on the basis of a radio frequency identification (RFID) technology, an infrared data association (IrDA) technology, an ultra wide band (UWB) technology, a Bluetooth (BT) technology, etc.

In the example, the user equipment 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, etc., for executing the methods described above.

Further provided in an example is a non-transitory computer-readable storage medium including an instruction, for example, a memory 804 including an instruction, where the instruction may be executed by a processor 820 of user equipment 800, so as to execute the method described above. For example, the non-transitory computer-readable storage medium may be an ROM, a random access memory (RAM), a compact disc read-only memory (CD-ROM), a magnetic tape, a floppy disk, an optical data storage device, etc.

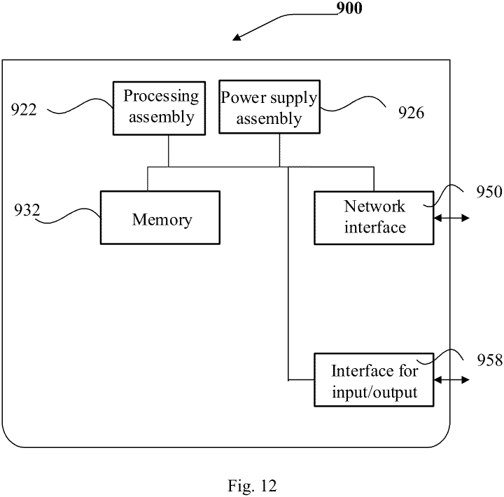

As shown in FIG. 12, an example of the disclosure provides a structure of a base station. For example, the base station 900 may be provided as a network-side device. With reference to FIG. 12, the base station 900 includes a processing assembly 922, which further includes one or more processors, and memory resources represented by a memory 932 for storing an instruction that may be executed by the processing assembly 922, for example, an application. The application stored in the memory 932 may include one or more modules that each correspond to a set of instructions. In addition, the processing assembly 922 is configured for executing an instruction, so as to execute any of the methods described above applied to the base station, for example, the methods shown in FIGS. 2-3.

The base station 900 may further include a power supply assembly 926 configured for executing power supply management of the base station 900, a wired or wireless network interface 950 configured for connecting the base station 900 to a network, and an interface 958 for input/output (I/O). The base station 900 may operate on the basis of an operation system stored in the memory 932, such as Windows Server™, Mac OS X™, Unix™, Linux™, FreeBSD™, etc.

Other implementation solutions to the disclosure will be easily conceived by those skilled in the art in consideration of the description and practice of the disclosure disclosed here. The disclosure is intended to cover any variations, uses, or adaptive changes of the disclosure following the general principles of the disclosure and including common general knowledge or conventional technical means within the technical field not disclosed in the disclosure. The description and the examples are deemed good examples only, and the true scope and spirit of the disclosure are indicated by the following claims.

It is to be understood that the disclosure is not limited to precise structures which have been described above and shown in the accompanying drawings, and may have various modifications and changes without departing from the scope of the disclosure. The scope of the disclosure is limited by the appended claims only.

1. A data transmission processing method, comprising:
sending, by a base station, beam recommendation information to user equipment (UE) before receiving uplink transmission on a configured grant-physical uplink shared channel (CG-PUSCH);
wherein the beam recommendation information at least indicates one of:
one or more recommended beams; or
the recommended beams can be selected by the UE to perform uplink transmission on the CG-PUSCH.

2. The method according to claim 1, wherein the recommended beam is one or more of a plurality of beams configured on the CG-PUSCH to perform uplink transmission.

3. The method according to claim 1, further comprising:
performing clear channel assessment (CCA) on an unlicensed channel before receiving the uplink transmission on the CG-PUSCH; wherein
sending beam recommendation information to user equipment (UE) comprises:
sending the beam recommendation information to the UE according to an assessment result of the CCA.

4. The method according to claim 3, wherein performing clear channel assessment (CCA) on the unlicensed channel comprises:
performing the CCA on a plurality of receiving beams on the unlicensed channel; wherein the receiving beam is for receiving the uplink transmission on the CG-PUSCH.

5. The method according to claim 3, wherein sending the beam recommendation information to the UE according to the assessment result of the CCA comprises:
sending the beam recommendation information to the UE in response to determining that there is at least one clear beam on the basis of the assessment result of the CCA.

6. The method according to claim 3, further comprising:
stopping sending the beam recommendation information in response to determining that no clear beam exists on the basis of the assessment result of the CCA.

7. The method according to claim 3, wherein performing clear channel assessment (CCA) on an unlicensed channel before receiving the uplink transmission on the CG-PUSCH comprises at least one of:
performing CCA on the unlicensed channel before receiving uplink transmission on each CG-PUSCH; or
performing CCA on the unlicensed channel before receiving uplink transmission on every N CG-PUSCHs; wherein N is a positive integer greater than or equal to 2.

8. The method according to claim 3, wherein performing clear channel assessment (CCA) on the unlicensed channel before receiving the uplink transmission on the CG-PUSCH comprises:
performing CCA on the unlicensed channel at a predetermined time domain position before receiving the uplink transmission on the CG-PUSCH.

9-11. (canceled)

12. A data transmission processing method, comprising:
receiving, by a user equipment (UE), beam recommendation information sent by a base station; wherein the beam recommendation information is sent by the base station before receiving uplink transmission on a configured grant-physical uplink shared channel (CG-PUSCH); and
selecting a beam for the UE to perform uplink transmission on the CG-PUSCH according to one or more recommended beams indicated by the beam recommendation information.

13. The method according to claim 12, wherein the recommended beam is one or more of a plurality of beams configured on the CG-PUSCH to perform uplink transmission.

14. The method according to claim 12, wherein the beam recommendation information is determined by the base station on the basis of an assessment result obtained by performing clear channel assessment (CCA) on an unlicensed channel; and the CCA is performed before receiving the uplink transmission on the CG-PUSCH.

15. The method according to claim 14, wherein the base station performs the CCA on a plurality of receiving beams on the unlicensed channel; wherein the receiving beam is a receiving beam for receiving the uplink transmission on the CG-PUSCH.

16. The method according to claim 14, wherein receiving beam recommendation information sent by a base station comprises:
receiving the beam recommendation information sent by the base station after determining that there is at least one clear beam on the basis of the assessment result of the CCA.

17. The method according to claim 14, wherein the CCA is performed on the unlicensed channel before receiving uplink transmission on each CG-PUSCH.

18. The method according to claim 14, wherein the CCA is performed on the unlicensed channel at a predetermined time domain position before receiving the uplink transmission on the CG-PUSCH.

19-42. (canceled)

43. A communication device, comprising:
a processor; and
a memory used for storing an executable instruction of the processor;
wherein, when running the executable instruction, the processor is configured to execute the instruction to:
send beam recommendation information to user equipment (UE) before receiving uplink transmission on a configured grant-physical uplink shared channel (CG-PUSCH);
wherein the beam recommendation information at least indicates one of:
one or more recommended beams; or
the recommended beams can be selected by the UE to perform uplink transmission on the CG-PUSCH.

44. A non-transitory computer storage medium, storing a computer executable program, wherein the executable program implements the data transmission processing method according to claim 1 when executed by a processor.

45. A communication device, comprising:
a processor; and
a memory used for storing an executable instruction of the processor;
wherein, when running the executable instruction, the processor is configured for implementing the data transmission processing method according to claim 12.

46. A non-transitory computer storage medium, storing a computer executable program, wherein the executable program implements the data transmission processing method according to claim 12 when executed by a processor.

47. The method according to claim 14, wherein the CCA is performed on the unlicensed channel before receiving uplink transmission on every N CG-PUSCHs; wherein N is a positive integer greater than or equal to 2.
